(19) United States
(12) Patent Application Publication
(10) Pub. No.: US 2014/0126131 A1
(43) Pub. Date: May 8, 2014

(54) DISPLAY DEVICE USING WINDOW

(71) Applicant: Samsung Display Co., Ltd., Yongin-City (KR)

(72) Inventor: Youn-Bum Lee, Yongin-City (KR)

(21) Appl. No.: 14/017,989

(22) Filed: Sep. 4, 2013

(30) Foreign Application Priority Data
Nov. 2, 2012 (KR) 10-2012-0123684

(51) Int. Cl. G06F 1/16

(52) U.S. Cl. CPC G06F 1/1601
USPC 361/679.3

(57) ABSTRACT

A display device using a window includes: a display panel; a window protecting the display panel from an external environment; and an adhesive layer adhering a top surface of the display panel to a bottom surface of the window. In the display device, the window has at least one irregularity on a bottom surface thereof. Accordingly, it is possible to provide a display device using a window having improved strength.

### CLAIM OF PRIORITY

This application makes reference to, incorporates into this specification the entire contents of, and claims all benefits accruing under 35 U.S.C. §119 from an application earlier filed in the Korean Intellectual Property Office filed on Nov. 2, 2012 and there duly assigned Serial No. 10-2012-0123684.

### BACKGROUND OF THE INVENTION

1. Field of the Invention

The present invention relates to a display device, and more particularly, to a display device using a window having improved strength.

2. Description of the Related Art

In general, a window substrate applied to a touch screen, such as a cellular phone, a portable terminal, or the like, is used to protect a display device, and performs the functions of preventing a scratch from being generated on the display device and protecting the display device from an external impact. Such a related art window substrate has high hardness so that its surface is protected from a scratch. However, when the window substrate falls due to a user's mistake or when an external strong impact is applied to the window substrate, the window substrate is easily broken.

### SUMMARY OF THE INVENTION

The present invention provides a display device using a window having improved strength.

According to an aspect of the present invention, there is provided a display device, including: a display panel; a window protecting the display panel from an external environment; and an adhesive layer adhering a top surface of the display panel to a bottom surface of the window, the window having at least one irregularity on the bottom surface thereof.

As described above, according to the present invention, it is possible to provide a display device using a window having improved strength by dispersing stress transferred to the window when an impact is applied to the display device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1A shows a section in which a window is attached to a display panel in a display device according to an embodiment of the present invention.

FIG. 1B shows a top surface of the display device shown in FIG. 1A.

FIG. 2A shows a section in which a window is attached to a display panel in a display device according to another embodiment of the present invention.

FIG. 2B shows a top surface of the display device shown in FIG. 2A.

FIG. 3A shows a section in which a window is attached to a display panel in a display device according to still another embodiment of the present invention.

FIG. 3B shows a top surface of the display device shown in FIG. 3A.

FIG. 4A shows a section in which a window is attached to a display panel in a display device according to still another embodiment of the present invention.

FIG. 4B shows a top surface of the display device shown in FIG. 4A.

FIG. 5A shows a section in which a window is attached to a display panel in a display device according to still another embodiment of the present invention.

FIG. 5B shows a top surface of the display device shown in FIG. 5A.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

Hereinafter, exemplary embodiments of the present invention will be described in detail with reference to the accompanying drawings.

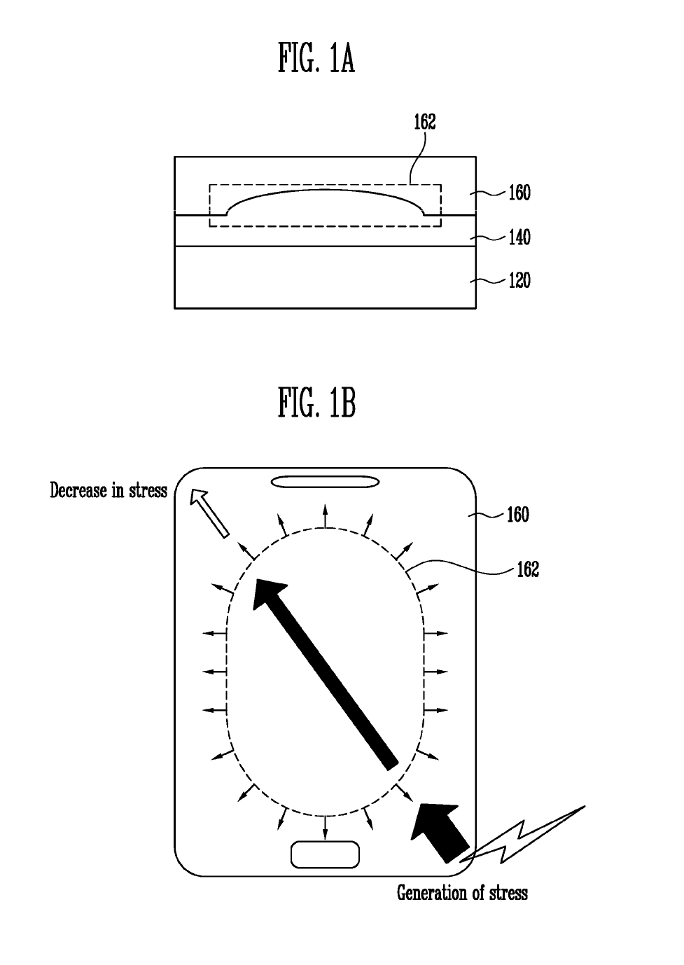

FIG. 1A shows a section in which a window is attached to a display panel in a display device according to an embodiment of the present invention. FIG. 1B shows a top surface of the display device shown in FIG. 1A.

First, referring to FIG. 1A, the display device includes a display panel 120, an adhesive layer 140 and a window 160.

The display panel 120 displays images. The display panel 120 may be a display panel such as a liquid crystal display (LCD) or organic light emitting diode (OLED) display.

The adhesive layer 140 is positioned between the display panel 120 and the window 160 so as to adhere the top surface of the display panel 120 to the bottom surface of the window 160. The adhesive layer 140 may be made of a photocurable resin or thermosetting resin having high transmittance and adhesion performance. For example, the adhesive layer 140 may be formed by coating resin such as acrylic resin, and then curing the coated resin through ultraviolet (UV) irradiation. The adhesive layer 140 has relatively excellent elasticity, so as to protect the display panel 120 from an external impact, thereby improving the mechanical stability and reliability of the display device.

The window 160 is positioned on the display panel 120 so as to protect the display panel 120 from an external environment. That is, the window 160 functions to prevent a scratch from being generated on the display panel 120 or to protect the display panel 120 from an external impact. The window 160 may be made of a transparent material. Specifically, the window 160 may be made of a plastic material, such as an acrylic material, or a glass material, which has impact resistance and optical transparency.

The window 160 has at least one irregularity on the bottom surface thereof. Specifically, the window 160 may have one concave pattern 162 formed at a central portion of the bottom surface thereof. The concave pattern 162 is a pattern in which the window 160 is recessed away from the display panel 120.

Referring to FIG. 1B, the window 160 has one concave pattern 162 formed at the central portion of the bottom surface thereof. Since the window 160 has a vertically long shape, the concave pattern 162 may have a vertically long elliptical shape. It will be apparent that the concave pattern 162 may have other shapes. If stress is generated by applying an impact to a right lower corner portion of the window 160, the stress is transferred to the opposite side, i.e., a left upper corner portion of the window 160. In a case where the bottom surface of the window 160 is a flat surface having no irregularity, the left upper corner portion of the window 160 is cracked or broken due to the impact applied to the right lower corner portion of the window 160. However, the display device according to this embodiment of the invention has the irregularity formed on the bottom surface of the window 160. The irregularity performs a buffering function with respect to the transferred stress. Specifically, referring to FIG. 1B, the concave pattern 162 formed on the stress transfer path disperses the transferred stress. The concave pattern 162 has an elliptical shape. Thus, if the stress is transferred to the concave pattern 162, the advancing direction of the stress is dispersed in all directions, so that the strength of the stress transferred to the left upper corner portion of the window 160 is decreased. As a result, the possibility that the left upper corner portion of the window 160 will be cracked or broken is remarkably reduced. It will be apparent that the shape and size of the concave pattern 162 may be appropriately defined. The resin constituting the adhesive layer 140 may be filled in the concave pattern 162.

Accordingly, the display device according to this embodiment of the invention has the concave pattern 162 formed at the central portion of the bottom surface of the window 160, and the concave pattern 162 of the window 160 performs a buffering function when an impact is applied to the window 160, so that the stress transferred to the opposite side of the impact point is decreased, thereby preventing the window 160 from being broken.

The display panel 120 may include a touch panel (not shown) sensing an external input so as to implement a touch screen. In this case, the touch panel (not shown) may be positioned on the display panel 120 or may be implemented inside the display panel 120. In a case where the touch panel (not shown) is positioned on the display panel 120, a first adhesive layer (not shown) is positioned on the display panel 120, the touch panel (not shown) is positioned on the first adhesive layer (not shown), a second adhesive layer (not shown) is positioned on the touch panel (not shown), and the window 160 is positioned on the second adhesive layer (not shown). The first and second adhesive layers (not shown) are similar to the adhesive layer 140 described above.

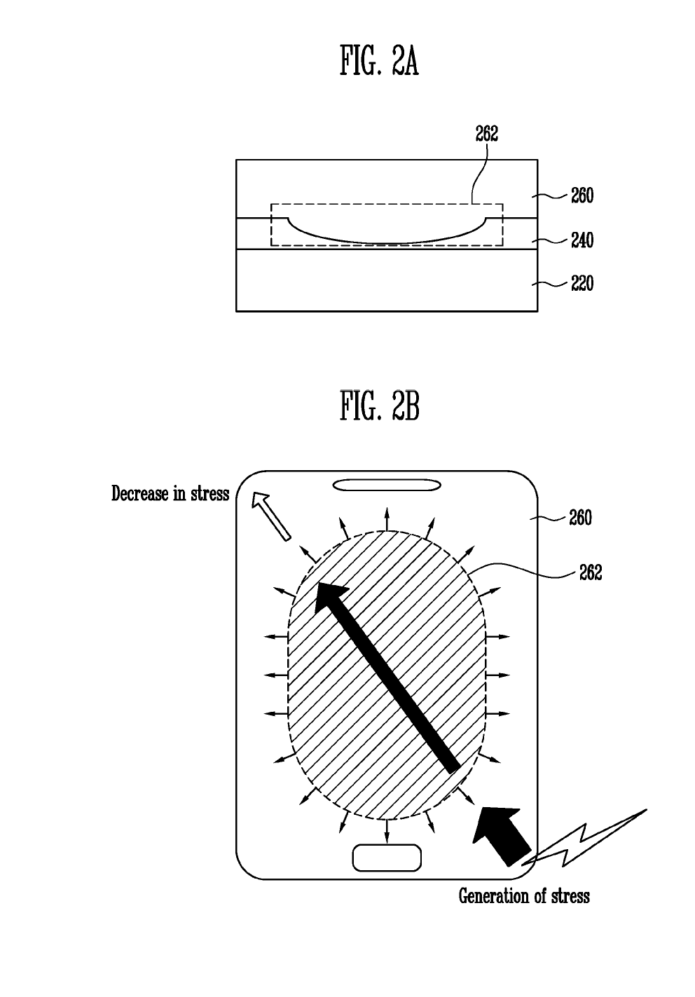

FIG. 2A shows a section in which a window is attached to a display panel in a display device according to another embodiment of the present invention. FIG. 2B shows a top surface of the display device shown in FIG. 2A.

First, referring to FIG. 2A, the display device according to this embodiment includes a display panel 220, an adhesive layer 240 and a window 260. This embodiment is similar to the embodiment of FIG. 1, except for the window 260. Hereinafter, the window 260 will be described in detail.

The window 260 has at least one irregularity on the bottom surface thereof. Specifically, the window 260 may have one convex pattern 262 formed at a central portion of the bottom surface thereof. The convex pattern 262 is a pattern in which the window 260 convexly protrudes toward the display panel 220.

Referring to FIG. 2B, the window 260 has one convex pattern 262 formed at the central portion of the bottom surface thereof. Since the window 260 has a vertically long shape, the convex pattern 262 may have a vertically long elliptical shape. It will be apparent that the convex pattern 262 may have other shapes. If stress is generated by applying an impact to a right lower corner portion of the window 260, the stress is transferred to the opposite side, i.e., a left upper corner portion of the window 260. The convex pattern 262 formed on the stress transfer path disperses the transferred stress. The convex pattern 262 has an elliptical shape. Thus, if the stress is transferred to the convex pattern 262, the advancing direction of the stress is dispersed in all directions, so that the strength of the stress transferred to the left upper corner portion of the window 260 is decreased. As a result, the possibility that the left upper corner portion of the window 260 will be cracked or broken is remarkably reduced. It will be apparent that the shape and size of the convex pattern 262 may be appropriately defined.

Accordingly, the display device according to this embodiment of the invention has the convex pattern 262 formed at the central portion of the bottom surface of the window 260, and the convex pattern 262 of the window 260 performs a buffering function when an impact is applied to the window 260 so that the stress transferred to the opposite side of the impact point is decreased, thereby preventing the window 260 from being broken.

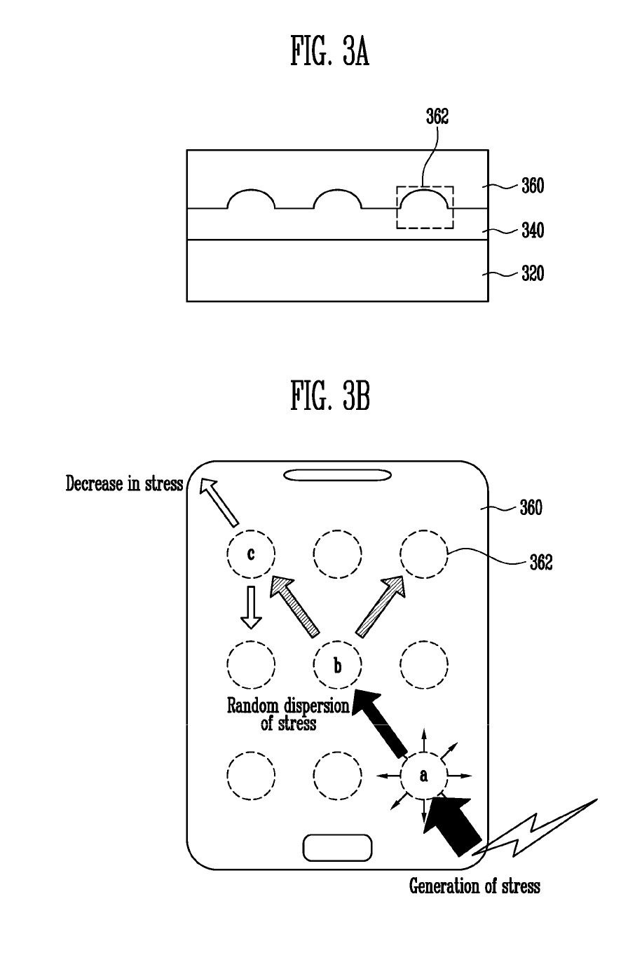

FIG. 3A shows a section in which a window is attached to a display panel in a display device according to still another embodiment of the present invention. FIG. 3B shows a top surface of the display device shown in FIG. 3A.

First, referring to FIG. 3A, the display device according to this embodiment includes a display panel 320, an adhesive layer 340 and a window 360. This embodiment is similar to the embodiments of FIGS. 1 and 2, except for the window 360. Hereinafter, the window 360 will be described in detail.

The window 360 has at least one irregularity on the bottom surface thereof. Specifically, the window 360 may have a plurality of concave patterns 362 formed on the bottom surface thereof. The concave pattern 362 is a pattern in which the window 360 is recessed away from the display panel 320.

Referring to FIG. 3B, the window 360 has nine concave patterns 362 formed on the bottom surface thereof. Each concave pattern 362 may have a circular shape. It will be apparent that the concave pattern 362 may have other shapes. If stress is generated by applying an impact to a right lower corner portion of the window 360, the stress is transferred to the opposite side, i.e., a left upper corner portion of the window 360. The concave patterns 362 formed on the stress transfer path disperse the transferred stress. Each concave pattern 362 has a circular shape. Thus, if the stress is transferred to each concave pattern 362, the advancing direction of the stress is dispersed in all directions, so that the strength of the stress transferred to the left upper corner portion of the window 360 is decreased. Specifically, in a case where the stress is generated at the right lower corner portion of the window 360, the stress transferred to a second concave pattern b is smaller than that transferred to a first concave pattern a, and the stress transferred to a third concave pattern c is smaller than that transferred to the second concave pattern b. The stress finally transferred to the left upper corner portion of the window 360 is smaller than that transferred to the third concave pattern c.

As a result, the possibility that the left upper corner portion of the window 360 will be cracked or broken is remarkably reduced. This is because the stress is dispersed as it passes through the concave patterns 362 one by one, and therefore, the stress advancing in a specific direction is decreased. It will be apparent that the shape and size of the concave pattern 362 may be appropriately defined. The resin constituting the adhesive layer 340 may be filled in the concave pattern 362.

Accordingly, the display device according to this embodiment of the invention has the plurality of the concave patterns 362 formed on the bottom surface of the window 360, and the concave patterns 362 of the window 360 perform a buffering function when an impact is applied to the window 360 so that the stress transferred to the opposite side of the impact point is decreased, thereby preventing the window 360 from being broken.

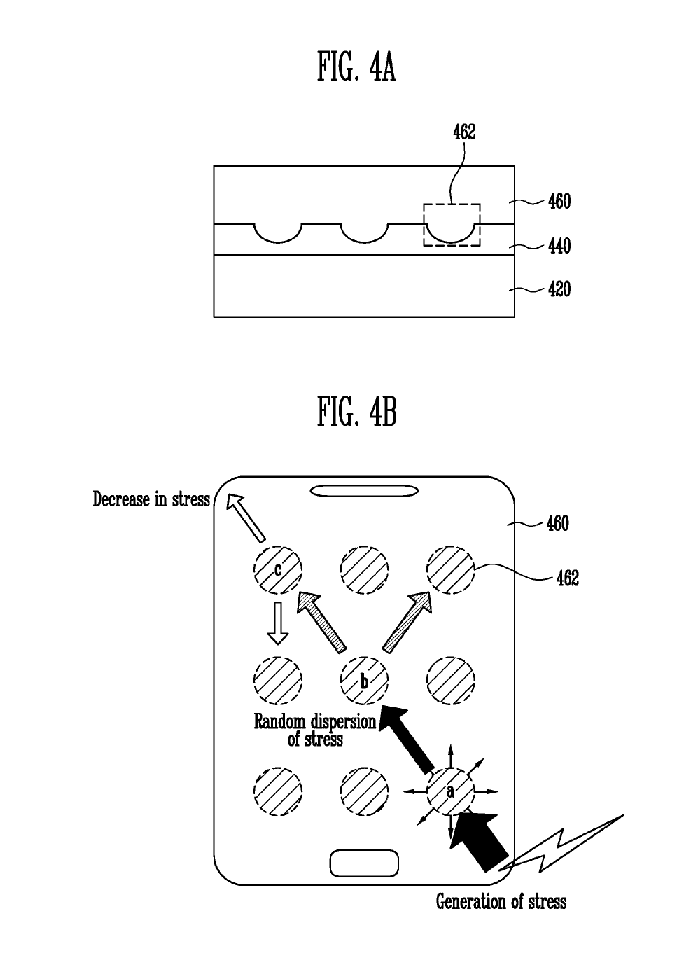

FIG. 4A shows a section in which a window is attached to a display panel in a display device according to still another embodiment of the present invention. FIG. 4B shows a top surface of the display device shown in FIG. 4A.

First, referring to FIG. 4A, the display device according to this embodiment includes a display panel 420, an adhesive layer 440 and a window 460. This embodiment is similar to the embodiments of FIG. 3, except for the window 460. Hereinafter, the window 460 will be described in detail.

The window 460 has at least one irregularity on the bottom surface thereof. Specifically, the window 260 may have a plurality of convex patterns 462 formed on the bottom surface thereof. The convex pattern 462 is a pattern in which the window 460 protrudes convexly toward the display panel 420.

Referring to FIG. 4B, the window 460 has nine convex patterns 462 formed on the bottom surface thereof. Each convex pattern 462 may have a circular shape. It will be apparent that the convex pattern 462 may have other shapes. If stress is generated by applying an impact to a right lower corner portion of the window 460, the stress is transferred to the opposite side, i.e., a left upper corner portion of the window 460. The convex patterns 462 formed on the stress transfer path disperse the transferred stress. Each convex pattern 462 has a circular shape. Thus, if the stress is transferred to each convex pattern 462, the advancing direction of the stress is dispersed in all directions so that the strength of the stress transferred to the left upper corner portion of the window 460 is decreased. Specifically, in a case where the stress is generated at the right lower corner portion of the window 460, the stress transferred to a second convex pattern b is smaller than that transferred to a first convex pattern a, and the stress transferred to a third convex pattern c is smaller than that transferred to the second convex pattern b. The stress finally transferred to the left upper corner portion of the window 460 is smaller than that transferred to the third convex pattern c.

As a result, the possibility that the left upper corner portion of the window 460 will be cracked or broken is remarkably reduced. This is because the stress is dispersed as it passes through the convex patterns 462 one by one, and therefore, the stress advancing in a specific direction is decreased. It will be apparent that the shape and size of the convex pattern 462 may be appropriately defined.

Accordingly, the display device according to this embodiment has the plurality of the convex patterns 462 formed on the bottom surface of the window 460, and the convex patterns 462 of the window 460 perform a buffering function when an impact is applied to the window 460 so that the stress transferred to the opposite side of the impact point is decreased, thereby preventing the window 460 from being broken.

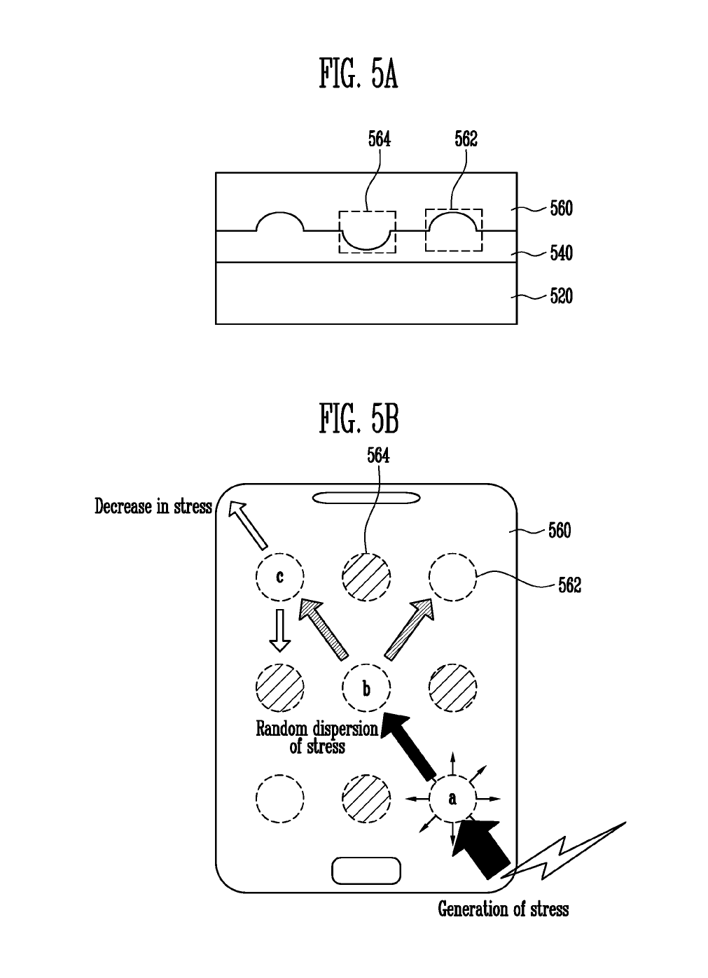

FIG. 5A shows a section in which a window is attached to a display panel in a display device according to still another embodiment of the present invention. FIG. 5B shows a top surface of the display device shown in FIG. 5A.

First, referring to FIG. 5A, the display device according to this embodiment includes a display panel 520, an adhesive layer 540 and a window 560. This embodiment is similar to the embodiments of FIGS. 3 and 4, except for the window 560. Hereinafter, the window 560 will be described in detail.

The window 560 has at least one irregularity on the bottom surface thereof. Specifically, the window 560 may have at least one concave pattern 562 and at least one convex pattern 564 on the bottom surface thereof. The concave pattern 562 is a pattern in which the window 560 is recessed away from the display panel 520. The convex pattern 564 is a pattern in which the window 560 is protrudes convexly toward the display panel 520. The concave pattern(s) 562 and the convex pattern(s) 564 may be alternately arranged.

Referring to FIG. 5B, the window 560 has five concave patterns 562 and four convex patterns 564 on the bottom surface thereof, and the concave patterns 562 and the convex patterns 564 are alternately arranged. Each concave pattern 562 and each convex pattern 564 may have a circular shape. It will be apparent that each concave pattern 562 and each convex pattern 564 may have other shapes. If stress is generated by applying an impact to a right lower corner portion of the window 560, the stress is transferred to the opposite side, i.e., a left upper corner portion of the window 560. The concave and convex patterns 562 and 564, respectively, formed on the stress transfer path disperse the transferred stress. Each of the concave and convex patterns 562 and 564, respectively, has a circular shape. Thus, if the stress is transferred to each of the concave and convex patterns 562 and 564, respectively, the advancing direction of the stress is dispersed in all directions so that the strength of the stress transferred to the left upper corner portion of the window 560 is decreased. Specifically, in a case where the stress is generated at the right lower corner portion of the window 560, the stress transferred to a convex pattern b is smaller than that transferred to a first concave pattern a, and the stress transferred to a second concave pattern c is smaller than that transferred to the convex pattern b. The stress finally transferred to the left upper corner portion of the window 560 is smaller than that transferred to the second concave pattern c.

As a result, the possibility that the left upper corner portion of the window 560 will be cracked or broken is remarkably reduced. This is because the stress is dispersed as it passes through the concave or convex patterns 562 or 564, respectively, one by one, and therefore, the stress advancing in a specific direction is decreased. It will be apparent that the shape and size of each of the convex and concave patterns 562 and 564, respectively, may be appropriately defined. The resin constituting the adhesive layer 540 may be filled in the concave pattern 562.

Accordingly, the display device according to this embodiment has at least one concave pattern 562 and at least one convex pattern 564 on the bottom surface of the window 560, and the concave and convex patterns 562 and 564, respectively, of the window 560 perform a buffering function when an impact is applied to the window 560 so that the stress transferred to the opposite side of the impact point is decreased, thereby preventing the window 560 from being broken.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display device, comprising:
a display panel;
a window protecting the display panel from an external environment; and
an adhesive layer adhering a top surface of the display panel to a bottom surface of the window;
the window having at least one irregularity on the bottom surface thereof.

2. The display device of claim 1, the irregularity being configured with one concave pattern.

3. The display device of claim 2, the concave pattern being positioned at a central portion of the bottom surface of the window.

4. The display device of claim 3, the adhesive layer being made of resin.

5. The display device of claim 4, the resin being filled in the concave pattern.

6. The display device of claim 1, the irregularity being configured with one convex pattern.

7. The display device of claim 6, the convex pattern being positioned at a central portion of the bottom surface of the window.

8. The display device of claim 7, the adhesive layer being made of resin.

9. The display device of claim 1, the irregularity being configured with a plurality of concave patterns formed at a predetermined position.

10. The display device of claim 9, the adhesive layer being made of resin.

11. The display device of claim 10, the resin being filled in the concave patterns.

12. The display device of claim 1, the irregularity being configured with a plurality of convex patterns formed at a predetermined position.

13. The display device of claim 12, the adhesive layer being made of resin.

14. The display device of claim 1, the irregularity being configured with at least one convex pattern and at least one concave pattern positioned at predetermined positions.

15. The display device of claim 14, the adhesive layer being made of resin.

16. The display device of claim 15, the resin being filled in said at least one concave pattern.

17. The display device of claim 16, said at least one convex pattern and said at least one concave pattern being alternately arranged.
